(19) United States
(12) Patent Application Publication
(10) Pub. No.: US 2024/0317180 A1
(43) Pub. Date: Sep. 26, 2024

(54) DE-ICING DEVICE, IN PARTICULAR FOR ARRANGEMENT IN A DASHBOARD OF A VEHICLE

(71) Applicant: Dr. Ing. h.c. F. Porsche Aktiengesellschaft, Stuttgart (DE)

(72) Inventor: Jan Bela, Sachsenheim (DE)

(21) Appl. No.: 18/599,338

(22) Filed: Mar. 8, 2024

(30) Foreign Application Priority Data
Mar. 21, 2023 (DE) 10 2023 107 002.9

(51) Int. Cl. B60S 1/02; B08B 7/00; B60K 35/40; G02B 27/01

(52) U.S. Cl. CPC B60S 1/026; B08B 7/0035; B60K 35/40; G02B 27/0101; B60K 2360/334; B60K 2360/336; G02B 2027/0196

(57) ABSTRACT

A de-icing device (2) is provided for arrangement on a dashboard (1) of a vehicle. The de-icing device (2) has an elongated channel (3) open on at least one side. The elongated channel (3) is configured to provide a heat flow (13). The de-icing device (2) also has a light emitter (4) arranged in the elongated channel (4). A dashboard (1) that includes the de-icing device (2) also is provided.

### CROSS-REFERENCE TO RELATED APPLICATION

This application claims priority on German Patent Application No 10 2023 107 002.9 filed Mar. 21, 2023, the entire disclosure of which is incorporated herein by reference.

### BACKGROUND

### Field of the Invention

The invention relates to a de-icing device for arrangement in or on a dashboard of a vehicle for de-icing a windshield in a vehicle.

### Related Art

Head-up displays are being installed increasingly in vehicles to project important information into the driver's field of view while driving. For this purpose, a projector usually is installed in the front of the dashboard and projects an image onto the windshield by means of a mirror system. The projection shows the information to be displayed directly in the driver's field of view and usually is perceived by the driver a few meters in front of the front hood of the vehicle.

At the same time, however, it is also important that the windshield always allows a clear view of the road and other aspects of the environment in front of the vehicle. For this purpose, an air outlet or defrost channel usually is provided at the root of the windshield and blows hot air onto the windshield as required to remove moisture or ice that has settled on the windshield.

Limited available design space for implementing the head-up display and the air outlet results in a conflict of goals at the windshield root between the head-up display and the defrost channel. This competition for space is exacerbated if a further functional unit is to be arranged in this area, such as an Interior Communication Light (ICL). The ICL is a light guide with LED elements that directly illuminates the occupants and communicates feedback or alerts by the displayed light color. In certain circumstances, it can be difficult to accommodate these three components on the dashboard in the area between the driver and the windshield root.

U.S. Pat. No. 5,305,011 discloses an instrument panel with a defrost channel and a projector arranged below the defrost channel for providing a head-up display. The defrost channel comprises a transparent bottom portion that is permeable to the light emitted from the projector.

DE 10 2011 055 156 A1 also discloses an instrument panel having a defrost channel and a projector for providing a head-up display. The defrost channel and the projector use a common exit opening of the instrument panel.

In the view of the foregoing, an object of the invention is to optimize the arrangement of the defrost channel and ICL or light guide elements on the dashboard.

### SUMMARY OF THE INVENTION

One aspect of the invention relates to integrating an ICL module into the window defrost channel. The ICL module typically includes the ICL and a light guide. Light emitted by the ICL can be emitted into the passenger compartment via window reflection. The light guide can be used to focus the light emitted by the ICL and can direct that light almost without loss to a predetermined exit area. In principle, both the defrost channel and the ICL module can extend over the entire width of the dashboard or windshield.

A de-icing device is provided in one embodiment and is arranged in or on a dashboard of a vehicle. The de-icing device comprises an elongated channel that is open on at least one side and is configured to provide a heat flow. A light emitter is arranged in the elongated channel. The channel can have air outlet openings through which warm air can flow out during operation for distributing the warm air across the entire width of the windshield. The light emitter can be a number of LEDs that form part of the ICL module. The LEDs can be arranged on a flexible strip and thus form a contiguous unit.

The light emitter can be elongated and extend along the length of the channel. For example, the light emitter can comprise an LED strip.

The light emitter can be arranged in a bottom of the elongated channel. For example, such as in a groove in the elongate channel. During assembly of the de-icing device, the light emitter can be inserted into the groove as a separate unit.

A light guide can be provided upstream of the light emitter. In other words, the light guide can be arranged in front of the light emitter, such that the light exiting the light emitter is radiated into the light guide and can exit again at the opposite end of the light guide. For example, the light guide can be hollow internally and can have mirrored internal walls to direct the incoming light as loss-free as possible. The light guide can be segmented along its length, i.e. have a series of multiple light guides. The light guide can be present with the light emitter in the form of an integrally designed light module that is connected to the channel as a separate unit, for example by being inserted into it.

The light guide can form a side wall of the elongated channel. Thus, the light guide can fulfill a dual role: namely providing the light guide, and also limiting the flow path of the warm air flowing through the elongated channel during operation.

The light guide of some embodiments has an elongated channel shape and is configured to direct light emitted by the light emitter towards the opening or the opening surface of the elongated channel. Thus, the light emitter can direct the light generated by the light emitter out of the channel.

A reflective surface can be at one end of the light guide and is configured to direct the light propagating through the light guide out from one side of the light guide. The reflective surface can be on the end of the light guide opposite the light emitter and can be used to determine the exit direction of the light propagating through the light guide. For example, the reflective surface can be aligned so that the light emitted from the light guide substantially from the channel in an upward direction is reflected from the side towards the passenger compartment. In this embodiment, there is no reflection on the windshield during the propagation of the light from the light emitter to the passenger compartment because the light instead is reflected into the passenger compartment by means of the reflective surface.

The light emitter and the light guide can form a light module comprising a mechanical interface by means of which the light module can be coupled to an element that forms a bottom and a side wall of the elongated channel. Thus, the de-icing device can be comprised of a first part formed by the light module and a second part formed by the bottom and the side wall of the elongated channel that is opposite the light module. A latching mechanism or other mechanism can be provided for assembling the two parts. For example, a groove or a protrusion can be provided on the edge of the light module, and a corresponding protrusion or groove can be provided on the adjacent edge of the channel by means of which the two parts can be attached to one another.

The previously described de-icing device can be arranged on the window-side edge of the dashboard so that the open side of the elongated channel is aligned upwards. As a result, the warm air can exit the channel at the open top and can flow from the windshield root along the windshield to dehumidify and/or de-ice the windshield.

The present invention is characterized in that more space is created on the dashboard by merging the defrost channel with the light emitter or the light module. Thus, more space is available for further components, such as a head-up display.

The aforementioned features and features yet to be explained can be used in the respectively specified combination, in other combinations or on their own, without departing from the scope of the invention.

Additional advantages and configurations of the invention result from the description and the enclosed drawing.

### BRIEF DESCRIPTION OF THE DRAWINGS

FIG. 1 shows a first embodiment of a dashboard having a de-icing device.

FIG. 2 shows a second embodiment of a dashboard having a de-icing device.

### DETAILED DESCRIPTION

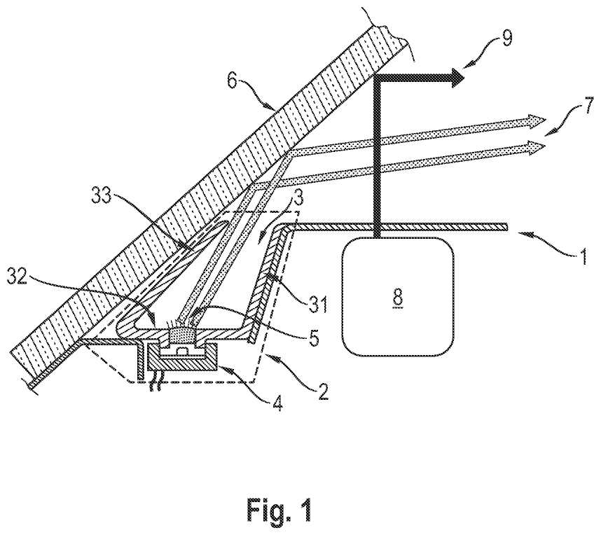

FIG. 1 illustrates a dashboard 1 having a de-icing device 2 according to a first embodiment of the invention. The illustration corresponds to a cross-sectional view taken along a line parallel to the vehicle longitudinal axis and from the driver's seat side. The de-icing device 2 is located at the lower root area of the windshield 6 and on the edge of the dashboard 1 adjacent the windshield 6.

The de-icing device 2 comprises an elongated channel 3 that is open at the top and configured to provide a heat flow. The elongated channel 3 comprises an inner or rear wall 31, a bottom 32 and an outer or front wall 33. A light emitter 4 is arranged at the bottom 32 of the channel 3. The light emitter 4 is integrated in the channel 3 and can comprise an LED or other suitable light source attached to the bottom 32 of the channel 3. In this embodiment, an opening 5 is provided in the bottom 32, and light generated by the light emitter 4 can pass through the opening 5 into the channel 3. The opening 5 is covered with a transparent plate that can either correspond to the normal housing of the light emitter 4 or represent an additional element. The transparent plate can also correspond to an optically active element to develop a lens effect on the light generated by the light emitter 4, for example, to direct its radiation more specifically to the opening of the channel 3. In this way, the transparent plate can correspond to a light guide. In any case, the opening 5 is closed so that foreign particles and hot air cannot penetrate into the opening 5 from the channel 3. The arrangement of the light emitter 4 at the bottom 32 of the channel is exemplary here. In further embodiments, the bottom 32 can be thicker and the light emitter 4 can be inserted in a groove that has a closed bottom, i.e. does not have the through-opening 5 shown in FIG. 1. The light beams 7 emitted by the light emitter 4 are emitted upwards and are reflected on the windshield 6 towards the occupants in the passenger compartment of the vehicle.

FIG. 1 also shows a head-up display 8 that is arranged in the front part of the dashboard 1. The light projection 9 of the head-up display 8 is also reflected towards the driver on the inside of the windshield 6. In the embodiment of FIG. 1, both the visibility of the light beams 7 generated by the light emitter 5 and thus the corresponding information to be displayed, and the visibility of the light projection 9 generated by the head-up display 8 are realized via the reflection on the windshield 6.

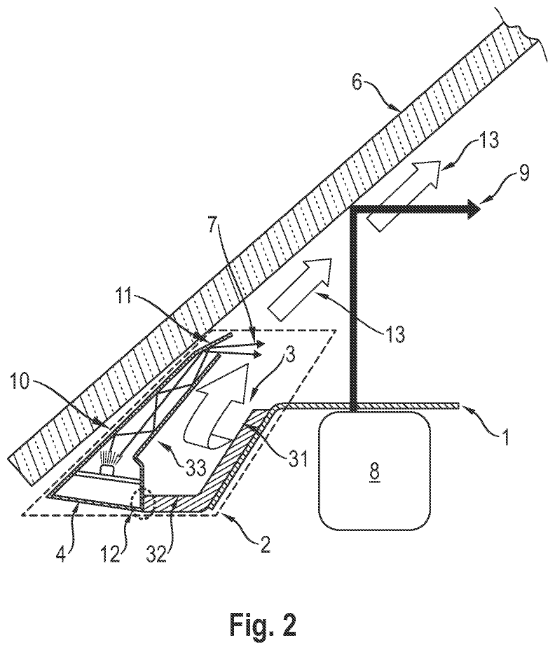

FIG. 2 depicts a second embodiment of a dashboard 1 having a de-icing device 2. The basic construction is similar to the construction of FIG. 1, and equivalent elements are provided with the same reference numbers.

The de-icing device 2 of FIG. 2 is located at the root of the windshield 6 and is arranged on the window-side edge of the dashboard 1. The light emitter 4 of FIG. 2 is arranged in the channel 3 on the side, and an elongated light guide 10 is positioned upstream. The light guide 10 serves to focus the light generated by the light emitter 4 and at the same time forms the outer side wall 33 of the elongated channel 3. A reflective surface 11 is arranged at the upper end of the light guide 10 so that the light beams 7 propagating through the light guide 10 are reflected away from the windshield 6 and towards the vehicle interior.

The light emitter 4 and the light guide 10 form a light module in the embodiment of FIG. 2, and the light module is coupled via a mechanical interface 12 to the remaining part of the channel 3, namely the bottom 32 and the inner side wall 31 of the elongated channel 3. The light guide 10 can be a waveguide with mirrored inside walls, as shown.

The light emitter 4 of FIG. 2 is coupled to the bottom 32 of the channel 3. However, a part of the bottom 32 of the channel 3 can also be formed on the light emitter 4 and thus correspond to a part of the light module. In other words, the mechanical interface 32 can be shifted towards the inner wall 31 of the channel 3.

The arrows 13 in FIG. 2 show the warm air flow exiting the channel 3 as a defrost channel to dehumidify and/or de-ice the inner side of the windshield 6. The surface of the light guide 10 that forms the inner wall 33 of the channel 3, can be formed from a material with relatively poor thermal conductivity (e.g. plastic) or provided with a thermally insulating coating to minimize the heat loss of the warm air exiting the channel 3.

In both embodiments, the de-icing module 2 can be glued to the dashboard or attached by fastening elements.

1. A de-icing device (2) for arrangement on a dashboard (1) of a vehicle, comprising:
an elongated channel (3) opened on at least one side and configured to provide a heat flow (13);
a light emitter (4) in the elongated channel (4).

2. The de-icing device (2) of claim 1, wherein the light emitter (4) is elongated and extends along the length of the channel (3).

3. The de-icing device (2) of claim 1, wherein the elongated channel (3) has a bottom (32) and the light emitter (4) is arranged in a bottom (32) of the elongated channel (3).

4. The de-icing device (2) of claim 1, further comprising a light guide (10) upstream of the light emitter (4).

5. The de-icing device (2) of claim 4, wherein the light guide (4) forms a side wall of the elongated channel (3).

6. The de-icing device (2) of claim 4, wherein the light guide (10) has an elongated shape and is configured to direct the light emitted by the light emitter (4) to the opening of the elongated channel (3).

7. The de-icing device (2) of claim 4, further comprising a reflective surface (11) arranged at one end of the light guide (10), such that the light propagating through the light guide (20) is directed laterally out of the light guide (10).

8. The de-icing device (2) of claim 5, wherein the light emitter (4) and the light guide (10) form a light module with a mechanical interface (12) by means of which it can be coupled to an element that forms a bottom (32) and a side wall (31) of the elongated channel (3).

9. A dashboard (1) for a vehicle, the dashboard (1) having an edge extending along a windshield (6) of the vehicle, the dashboard (1) comprising:
an elongated channel (3) extending along the edge of the dashboard (1), the elongated channel (3) having an open side that is open up toward the windshield (6);
a de-icing device (2) configured to provide a heat flow (13) through the elongated channel (3) and upward from the open side of the elongated channel (3) toward the windshield (6); and
a light emitter (4) in the elongated channel (4).

10. The dashboard (1) of claim 9, wherein the light emitter (4) is elongated and extends along the length of the channel (3).

11. The dashboard (1) of claim 9, wherein the elongated channel (3) has a bottom (32) and the light emitter (4) is arranged in a bottom (32) of the elongated channel (3).

12. The dashboard (1) of claim 9, further comprising a light guide (10) upstream of the light emitter (4).

13. The dashboard (1) of claim 12, wherein the light guide (4) forms a side wall of the elongated channel (3).

14. The dashboard (1) of claim 12, wherein the light guide (10) has an elongated shape and is configured to direct the light emitted by the light emitter (4) to the opening of the elongated channel (3).

15. The dashboard (1) of claim 12, further comprising a reflective surface (11) arranged at one end of the light guide (10), such that the light propagating through the light guide (20) is directed laterally out of the light guide (10).

16. The dashboard (1) of claim 12, wherein the light emitter (4) and the light guide (10) form a light module with a mechanical interface (12) by means of which it can be coupled to an element that forms a bottom (32) and a side wall (31) of the elongated channel (3).

17. The dashboard (1) of claim 9, further comprising a head-up display (8) disposed so that the elongated channel (3) is between the windshield (6) and the head-up display (8), the head-up display (8) directing a light projection (9) upward and toward the windshield (6).
